(19) United States
(12) Patent Application Publication
(10) Pub. No.: US 2016/0092844 A1
(43) Pub. Date: Mar. 31, 2016

(54) MEETING ATTENDANCE CONFIRMATION

(71) Applicant: Cisco Technology, Inc., San Jose, CA (US)

(72) Inventors: Rory ZHANG, HEFEI (CN); Bin ZHU, Suzhou (CN); Guang XU, Hefei (CN); Dong ZHANG, HEFEI (CN); Juanny WANG, HangZhou (CN)

(21) Appl. No.: 14/499,291

(22) Filed: Sep. 29, 2014

(51) Int. Cl. G06Q 10/10

(52) U.S. Cl. CPC G06Q 10/1095

(57) ABSTRACT

In one embodiment, a method for confirming attendance in a meeting is implemented on a computing device and includes: presenting a request to confirm attendance of a scheduled meeting, where the presenting is performed at a confirmation time associated with the scheduled meeting, and the confirmation time is determined as a function of a scheduled start time for the scheduled meeting, receiving a confirmation response to the request, receiving details of other confirmation responses provided by expected attendees of the scheduled meeting; and displaying an attendee confirmation status report on the computing device, where the attendee confirmation status report includes at least the details of the other confirmation responses.

### FIELD OF THE INVENTION

The present invention generally relates to meeting attendance, and particularly, but not exclusively, to the timely provision of confirmation of such attendance.

### BACKGROUND OF THE INVENTION

Applications for scheduling and/or attending meetings are well known in the Art. Such meetings are typically initiated by a host user sending meeting invitations to invitees, i.e. prospective attendees. Each invitee is typically prompted to respond by either: accepting, tentatively accepting, or declining the invitation. The host user and the other invitees are typically provided with a display indicating the responses for each of the invitees.

The applications are typically configured to add the details of a meeting invitation to personal calendars associated with the expected attendees, i.e. the invitees that accepted the invitation (either tentatively or otherwise), and to send them reminder notices at configured intervals before the scheduled start of the meeting.

### BRIEF DESCRIPTION OF THE DRAWINGS

The present invention will be understood and appreciated more fully from the following detailed description, taken in conjunction with the drawings in which:

FIG. 1 is a simplified pictorial illustration of an exemplary meeting attendance confirmation user interface screen, constructed and operative in accordance with embodiments of the present invention;

FIG. 2 is a simplified pictorial illustration of an exemplary computing device, constructed and operative in accordance with an embodiment of the present invention;

FIG. 3 is a simplified pictorial illustration of an exemplary meeting confirmation system, constructed and operative in accordance with an embodiment of the present invention;

FIG. 4 is a meeting confirmation process to be performed by the computing device of FIG. 2 in the system of FIG. 3; and

FIG. 5 is a simplified pictorial illustration of a meeting confirmation status display, constructed and operative in accordance with embodiments of the present invention.

### DESCRIPTION OF EXAMPLE EMBODIMENTS

### Overview

A method for confirming attendance in a meeting is implemented on a computing device and includes: presenting a request to confirm attendance of a scheduled meeting, where the presenting is performed at a confirmation time associated with the scheduled meeting, and the confirmation time is determined as a function of a scheduled start time for the scheduled meeting, receiving a confirmation response to the request, receiving details of other confirmation responses provided by expected attendees of the scheduled meeting, and displaying an attendee confirmation status report on the computing device, where the attendee confirmation status report includes at least the details of the other confirmation responses.

### Detailed Description of Example Embodiments

It will be appreciated that it is not uncommon for a meeting invitee to accept a meeting invitation with the intention of attending the meeting, but, for whatever reason, be unable to actually attend the meeting when it takes place. In such a case, the host user and other invitees may be under the impression that the meeting invitee will still be attending, as per the initial acceptance, and delay the start of the meeting needlessly while waiting for an invitee that may never actually attend.

It will similarly be appreciated that an invitee that does intend to attend a meeting may be delayed for whatever reason, and may therefore be unable to join the meeting as it starts. Depending on the circumstances, the host user and other invitees may or may not wait for the delayed invitee, and in any case, may be unsure as to how to proceed given the uncertainty created by the invitee's non-attendance.

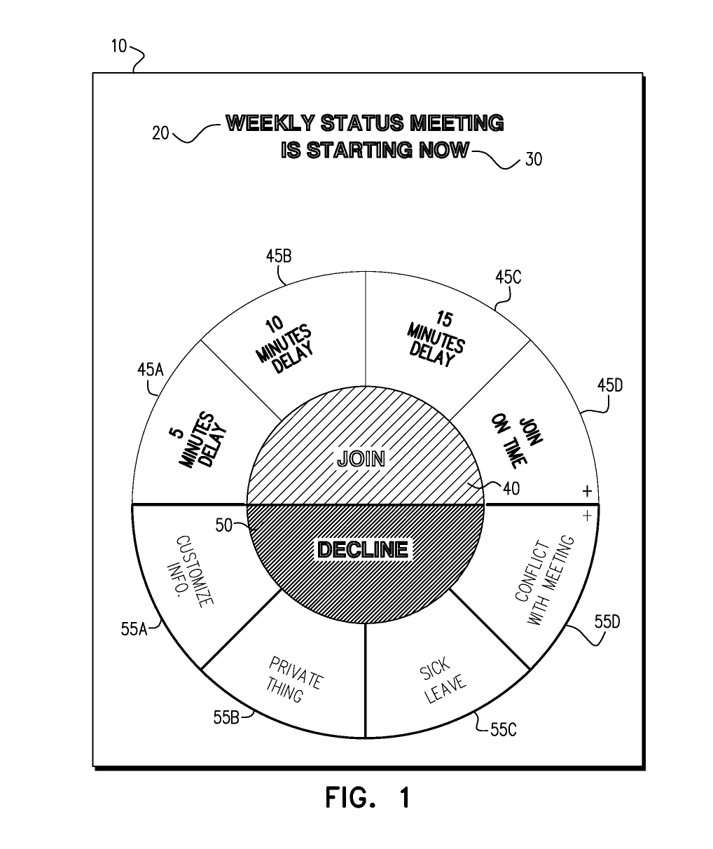

FIG. 1, to which reference is now made, shows an exemplary meeting attendance confirmation user interface (UI) screen 10, constructed and operative in accordance with embodiments of the present invention. Meeting attendance confirmation UI screen 10 comprises meeting title 20, meeting time indicator 30, join button 40 and decline button 50. Screen 10 may be used by an expected attendee to indicate to a host user and/or the other expected attendees' a current status vis-à-vis actual attendance of a meeting.

Meeting attendance confirmation UI screen 10 may be configured to be presented to an expected attendee as a pop-up window at one or more points in time prior to a scheduled meeting start, for example, five, ten and/or fifteen minutes prior to the scheduled start time. In operation, the expected attendee may use join button 40 to join the meeting, i.e. to confirm attendance. Similarly, the expected attendee may use decline button 50 to indicate non-attendance.

Alternatively or in addition, meeting attendance confirmation UI screen 10 may comprise join option buttons 45. Whereas join option 40 may indicate a general confirmation of the expected attendee's intention to join the meeting, join options 45 may be used to provide additional information regarding when the expected attendee expects to join the meeting. For example, join option button 45A may be used to indicate that the expected attendee will join the meeting five minutes after its start. Similarly, join option button 45B may indicate that the expected attendee will be ten minutes late; join option button 45C may indicate that the expected attendee will be fifteen minutes late. Join option button 45D may indicate that the expected attendee will be joining on time.

Similarly, meeting attendance confirmation UI screen 10 may comprise decline option buttons 55 which may be used to provide additional information regarding the expected attendee's reasons for declining to join the meeting. For example, decline option button 55B may be used to indicate that the expected attendee has a private engagement that is preventing attendance; decline option button 55C may be used to indicate that the expected attendee is sick; decline option button 55D may be used to indicate that the expected attendee has a conflict with another meeting. Decline option button 55A may be customizable, i.e. the user may customize its associated reasoning for declining.

It will be appreciated that the set of join option buttons 45 and decline option buttons 55 in FIG. 1 may be exemplary; the present invention may support any suitable set of such option buttons 45 and 55. For example, there may be more or less than four join option buttons 45, some of which may be associated with different delay periods. Similarly, there may be one or more customizable join option buttons analogous to decline option button 55. There may also be more or less than four decline option buttons 55, some of which may be associated with different reasons for declining than those depicted in decline option buttons 55.

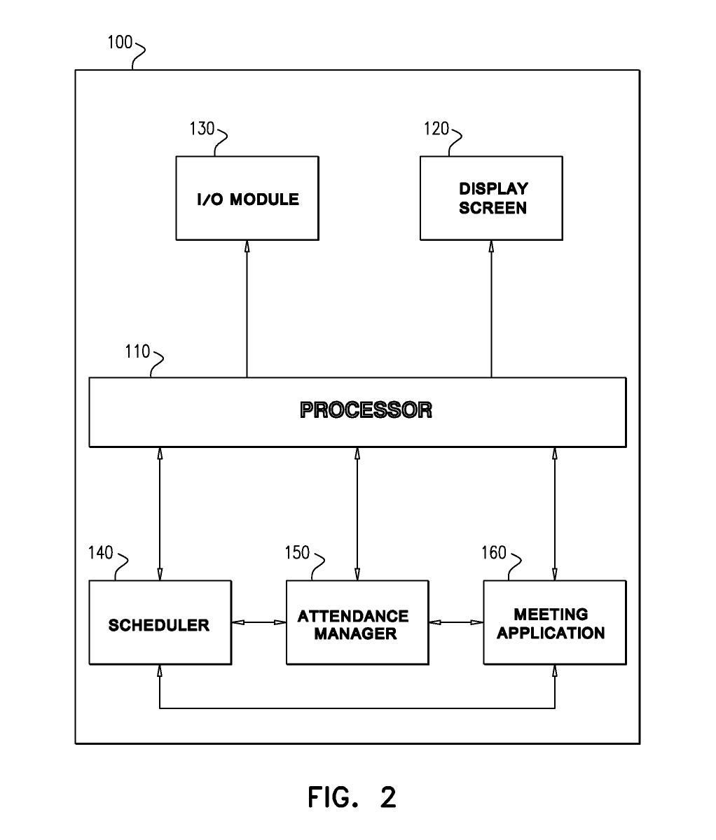

Reference is now made to FIG. 2, which is a block diagram illustration of an exemplary computing device 100. Computing device 100 may be any suitable computing device operative to present meeting attendance confirmation UI screen 10 for use. For example, computing device 100 may be a personal computer, a smartphone, a tablet computer, or a laptop computer, etc. Computing device 100 comprises: at least one processor 110; display screen 120; I/O module 130; scheduler 140; attendance manager 150 and meeting application 160. It will be appreciated that computing device 100 comprises hardware and software components, such as are well-known in the art. It will similarly be appreciated that computing device 100 may comprise other components that are not depicted in FIG. 2.

It will be appreciated that computing device 100 may comprise more than one processor 110. For example, one such processor 110 may be a special purpose processor operative to execute attendance manager 150 to present and operate meeting attendance confirmation UI screen 10 on display screen 120.

It will be appreciated that attendance manager 150 may be an application implemented in software and/or hardware on computing device 100. Meeting application 160 may be any suitable application installed on computing device 100 that may be operative to enable a user of device 100 to participate in a meeting. Non limiting examples of such applications may be WebEx® from Cisco Systems, Inc., Lync® from Microsoft Corporation, and GoToMeeting® from Citrix Systems.

Scheduler 140 may be any suitable calendar application installed on computing device 100 that may be operative to schedule meetings, for example, Outlook® from Microsoft Corporation or Google Calendar from Google, Inc. It will be appreciated that meeting application 160 and scheduler 140 may be implemented in software and/or hardware on computing device 100. It will similarly be appreciated that the depiction of attendance manager 150, meeting application 160 and scheduler 140 as separate and distinct entities may be exemplary. The present invention may also support the integration of some or all of the functionality of attendance manager 150 as part of meeting application 160 and/or scheduler 140. Similarly, some or all of the functionality of meeting application 160 may be integrated as part of scheduler 140. Likewise, some or all of the functionality of scheduler 140 may be integrated as part of meeting application 160.

It will also be appreciated that the depiction of attendance manager 150, meeting application 160 and scheduler 140 as components of computing device 100 may be exemplary. Computing device 100 may also be configured to receive some or all of the functionality of attendance manager 150, meeting application 160 and scheduler 140 as services provided by other computing devices accessed via a network such as the Internet.

Display screen 120 may be a display screen operative to display views generated by applications such as, for example, attendance manager 150, meeting application 160 and scheduler 140, and/or the operating system (not shown) of computing device 100. It will be appreciated that depending on the configuration of computing device 100, display screen 120 may be a touchscreen, operative to receive input from a user via UI gestures entered in contact with, or in close proximity to, display screen 120. Input/output I/O module 130 may be a software or hardware component such as, for example, a transceiver, operative to transmit and receive data at least in support of attendance manager 150, meeting application 160 and scheduler 140.

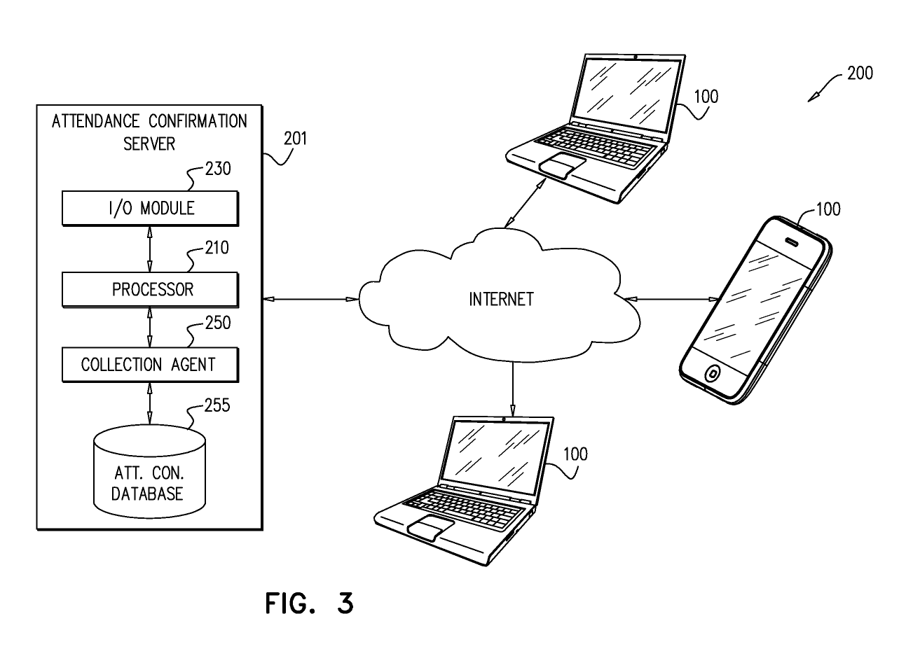

Reference is now also made to FIG. 3, which illustrates an exemplary meeting confirmation system 200, constructed and operative in accordance with an embodiment of the present invention. System 200 comprises a multiplicity of computing devices 100 which communicate with attendance confirmation server 201 via a network such as, for example, the Internet. Attendance confirmation server 201 comprises processor 210, I/O module 230, collection agent 250 and attendance collection database 255. It will be appreciated that processor 210 and I/O module 230 may be functionally and technically similar to processor 110 and I/O module 130, respectively.

As will be described hereinbelow, collection agent 250 may be operative to receive attendance confirmation data from computing devices 100 via I/O module 230. Collection agent 250 may be an application implemented in software and/or hardware, and may also be operative to store the attendance confirmation data in attendance confirmation database 255.

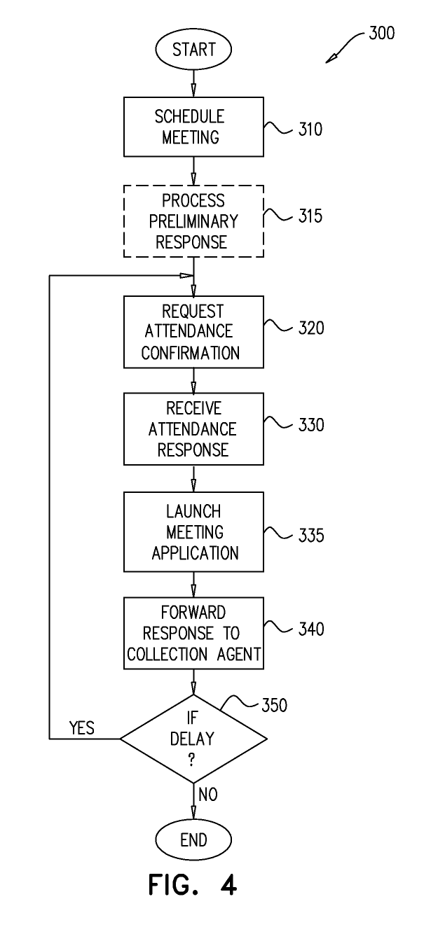

Reference is now also made to FIG. 4 which illustrates an attendance confirmation process 300 to be performed by computing device 100 (FIG. 2) within the context of system 200 in accordance with embodiments of the present invention. Scheduler 140 may schedule (step 310) a meeting for an expected attendee, i.e. a user of computing device 100. It will be appreciated that the meeting may or may not be initiated by the user of computing device 100; i.e. step 310 may be initiated as part of an invitation process where a host user sends out meeting invitations, and/or by the receipt of an invitation by an invitee using computing device 100. As part of the scheduling process, scheduler 140 may forward an indication of the host user or an invitee's expected attendance status, either directly or indirectly to the other invitees. Non-limiting examples of such an expected attendance status may typically include “accept”, “decline” or “tentatively accept” a meeting invitation.

It will be appreciated by one of skill in the art that the scheduled meeting may or may not require meeting application 160 in order for the expected attendee to attend the now scheduled meeting. For example, if the scheduled meeting is a video conference, meeting application 160 may be a video conference application that the expected attendee may use to join the video conference. However, it will be appreciated that the present invention may also support a scenario in which the scheduled meeting is attended in person. For example the expected attendee may join the meeting by simply walking into a conference room. It will also be appreciated that meeting application 160 may not necessarily be dedicated to providing access to meetings, per se. For example, meeting application 160 may be a telephone application that may be used to enable an expected attendee to call into a conference call. For the purposes of illustration, the following description will assume that meeting application 160 is used by the expected attendee to attend the meeting. However, it will be appreciated that the present invention may support a scenario in which meeting application 160 is not necessary for the expected attendee to join the meeting.

As part of step 310, scheduler 140 may forward the details of the scheduled meeting to attendance manager 150. Scheduler 140 may also interact with meeting application 160 to populate the scheduled meeting, i.e. the calendar item in the calendar maintained by scheduler 140, with any details that may be necessary for the expected attendee to eventually join the scheduled meeting. For example, if the scheduled meeting is a video conference, scheduler 140 may receive connection instructions (such as, for example, a uniform resource locator to access in order to join the meeting) from meeting application 160.

As discussed hereinabove, scheduling applications may typically prompt invitees to indicate whether or not they will be attending the scheduled meeting. Scheduler 140 may optionally process (step 315) the invitee's response and forward the response to attendance manager 150. It will be appreciated that the behavior of attendance manager 150 may be configurable based on the response entered by the invitee. For example, if the response is a tentative acceptance of the invitation, attendance manager 150 may be configured to continue processing the scheduled event as described hereinbelow. Alternatively, attendance manager 150 may be configured to only process definite acceptances. Attendance manager 150 may also be configured to process all scheduled events, even if the user of device 100 did not respond to an invitation to the meeting, or even expressly declined the invitation. Accordingly, step 315 may not be necessary, depending on the configuration of attendance manager 150.

Attendance manager 150 may be configured to request (step 320) attendance confirmation by displaying meeting attendance confirmation UI screen 10 (FIG. 1) at some point prior to the start of the scheduled meeting. For example, screen 10 may be displayed as a popup application half an hour, five, ten, fifteen or twenty minutes before the scheduled start time of the meeting. It will be appreciated that the present invention may also support or notification methods, including, for example, text messages, audio notifications, etc. It will also be appreciated that as briefly discussed hereinabove, some or all of the functionality of attendance manager 150 and scheduler 140 may be combined into a single unit. As scheduler 140 may already be monitoring a calendar associated with the user of computing device 100, the functionality for timing step 320 may be provided by integrating at least this functionality into attendance manager 150, or by integrating attendance manager into scheduler 140. Alternatively, the functionality may be provided by a separate module of attendance manager 150.

Attendance manager 150 may receive (step 330) the response via meeting attendance confirmation UI screen 10 as discussed hereinabove within the context of the discussion of FIG. 1. If the response is to join, i.e. the user selected join button 40, attendance manager 150 may optionally launch (step 335) meeting application 160 in order to enable the expected attendee to join the meeting.

Attendance manager 150 may forward (step 340) the response to collection agent 250 on attendance confirmation server 201 (FIG. 3) via I/O modules 130 and 230. Collection agent 250 may store the response in attendance confirmation database 255.

It will be appreciated that as discussed hereinabove, the response received in step 330 may be that the expected attendee will join after a delay, e.g. a delay of five, ten or fifteen minutes from the scheduled start of the meeting. If the response indicates that there will be a delay before the expected attendee joins the meeting (step 350), control may return to step 320, where attendance manager 150 may perform step 320 again. It will be appreciated that the timing for the re-performing of step 320 may be based on the length of the delay indicated in the response. For example, if a fifteen minute delay was indicated, attendance manager 150 may be configured to perform step 320 five, ten or fifteen minutes after the scheduled start time of the meeting. Process 300 may continue looping from step 320 through to step 350 and back again until the response enters a non-delay response, i.e. either a join or join on time (via join button 40 or join option button 45D), or a decline (via decline button 50 or a decline option button 45). Once such a “non-delay” response (step 350) is received, process 300 may flow through step 350 and end.

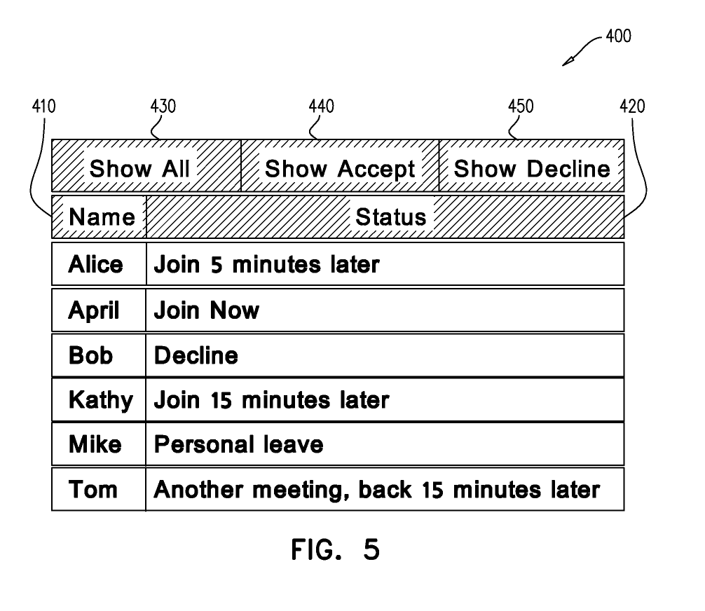

As discussed hereinabove, the responses from each computing device 100 may be forwarded to attendance confirmation server 201 and stored in attendance confirmation database 255. It will be appreciated that these responses may be used to generate a confirmed attendance report detailing the confirmed status of the expected attendees of a given scheduled meeting. Reference is now made to FIG. 5 which illustrates an exemplary confirmed attendance status screen 400, constructed and operative in accordance with embodiments of the present invention. Screen 400 comprises name column 410 and status column 420 which illustrate respectively the names of the expected attendees of a given meeting, and their confirmation status as indicated by their responses entered on meeting attendance confirmation UI screen 10. Viewing screen 400 may be operative to filter the display on screen 400 via user selection of show all button 430, show accept button 440 and show decline button 450.For example, in response to a selection of show accept button 440, the display for screen 400 may be refreshed to show only invitees that have accepted invitations to the meeting.

Screen 400 may be presented by attendance manager 150 on a computing device 100 associated with the host user of the scheduled meeting. System 200 may also be configured to enable the host user to allow other expected attendees to view screen 400 as well. System 200 may also be configured to allow all of the expected attendees to view screen 400.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present invention.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

What is claimed is:

1. A method for confirming attendance in a meeting, the method implemented on a computing device and comprising:
presenting a request to confirm attendance of a scheduled meeting, wherein said presenting is performed at a confirmation time associated with said scheduled meeting, and said confirmation time is determined as a function of a scheduled start time for said scheduled meeting;
receiving a confirmation response to said request;
receiving details of other confirmation responses provided by expected attendees of said scheduled meeting; and
displaying an attendee confirmation status report on said computing device, wherein said attendee confirmation status report comprises at least said details of other confirmation responses.

2. The method according to claim 1 and also comprising:
forwarding said confirmation response to a collection agent, wherein said collection agent is operative to receive said details of other confirmation responses, and wherein said details of other confirmation responses are received from said collection agent.

3. The method according to claim 1 and wherein said confirmation response is either a join response, wherein a join response is indicative of confirming attendance for said scheduled meeting, or a decline response, wherein said decline response is indicative of declining to attend said scheduled meeting.

4. The method according to claim 3 and wherein said join response also indicates an expected delay before attending.

5. The method according to claim 3 and also comprising:
launching a meeting application to enable said user to join said scheduled meeting in accordance with said confirmation response.

6. The method according to claim 1 and wherein said user is a host user for said scheduled meeting.

7. The method according to claim 1 and wherein said user receives permission from a host user to perform:
said receiving details of other confirmation responses; and
said displaying.

8. The method according to claim 4 and also comprising:
performing said presenting a request and said receiving a confirmation response in accordance with said expected delay.

9. The method according to claim 3 and wherein said decline response is indicative of a reason for declining.

10. The method according to claim 1 and wherein said presenting comprises presenting configurable response options for said confirmation response.

11. The method according to claim 5 and wherein said meeting application is a video conferencing application.

12. The method according to claim 5 and wherein said meeting application is a telephony based application.

13. The method according claim 1 and wherein said scheduled meeting is an in-person meeting.

14. The method according to claim 1 and wherein said user did not provide a response to an invitation for said meeting.

15. The method according to claim 1 and wherein said user provided a decline response to an invitation for said meeting.

16. A meeting attendance confirmation device comprising:
a processor;
a scheduler to be run by said processor and operative to schedule a meeting for a user of said device; and
an attendance manager to be run by said processor and operative:
to prompt said user to input a confirmation response at a confirmation time determined as a function of a scheduled start time for said scheduled meeting, wherein said confirmation response is indicative of whether or not said user expects to attend said scheduled meeting,
to receive said confirmation response, and
to display a listing of said confirmation responses provided by other expected attendees of said scheduled meeting.

17. The device according to claim 16 and also comprising:
a meeting application to be run by said processor and operative to enable said user to join said scheduled meeting.

18. The device according to claim 16 and wherein said attendance manager is integrated as a component of said scheduler.

19. The device according to claim 17 and wherein said attendance manager is integrated as a component of said meeting application.

20. The device according to claim 16 and also comprising an I/O module run by said processor and operative to communicate with a collection agent to send said received confirmation response, and to receive said listing of confirmation responses provided by other expected attendees of said scheduled meeting.
